(19) United States
(12) Patent Application Publication
(10) Pub. No.: US 2004/0088474 A1
(43) Pub. Date: May 6, 2004

(54) NAND type flash memory disk device and method for detecting the logical address

(76) Inventor: Jin Shin Lin, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/283,295

(22) Filed: Oct. 30, 2002

(51) Int. Cl. G06F 12/00

(52) U.S. Cl. 711/103; 711/104; 711/202

(57) ABSTRACT

The present invention directly copies and constructs a partial inverse physical/logical address mapping table via a relation between a physical address and its corresponding logical address at the beginning of turning-on the system and storing the partial inverse physical/logical address mapping table (AMT) in a random access memory (RAM). Then, the function of the memory disk device, which is composed of a counter, a comparator or other hardware, is utilized to sequentially search the partial inverse physical/logical address mapping table (AMT) in a random access memory (RAM) until to obtain the corresponding physical address to the awaited-searching logical address. Hence, the present invention can obtain an effectively balance between the process speed and the space. The present invention does not occupy too much space on the premise of keeping fast processing speed.

### BACKGROUND OF THE INVENTION

1. Field of the Invention

The present invention generally relates to a NAND type flash memory disk device and method for detecting the logical address, and more particularly relates to utilize the semiconductor disk device to form a physical/logical address mapping table (AMT) or look-up table so as to detect the logical address via the address mapping table.

2. Description of the Prior Art

According to the operation theorem of the memory, when the central processing unit (CPU) uses the memory as its data storage region, the calculating result and the data are stored herein. If the program needs to use the data or the calculating result therein, the data or the calculating result can be accessed from the storage region. As storing and reading the data, the central processing unit will define the required data with a position of the memory, the central processing unit sends the address to the memory via the position bus and then the data will transfers the corresponding data to the correct address. The reading time is the most important thing for the memory; from the central processing unit commanding the order to obtain the address data, transferring the data to the central processing unit after the memory responding, and then until the central processing unit actually receiving the data; wherein the spending time of the mentioned procedure is the accessing time of the memory.

However, in the flash memory, several bytes composes a block as an unit to execute the storage and the reading of the data, wherein each data-accessing block provides with a physical address for presenting the space sequence of the flash memory, such as the position of the physical address of the static random access memory (SRAM). Simultaneously, each block records the logical address indicated by the disk file system, such as shown in the FIG. 1a, and each physical address provides with a corresponding logical address. However, the mechanism of the flash memory, the data accessing of the file system requires the physical address and the logical address as a non-linear corresponding relation, which can not infer the position of the physical address from the logical address. Prior technology usually provides two methods for obtaining the corresponding logical address.

The first method is constructing a logical/physical address mapping table at the beginning of turning-on the system, wherein the logical/physical address mapping table is recording the corresponding relation between the logical address and the physical address and is devised a plurality of static random access memory (SRAM) therein to store and record the logical/physical address mapping table. Referring to the FIG. 1, to construct the address mapping table is mainly used the arrangement sequence of the logical address and then to fill the corresponding physical address into the content of the address mapping table. Because the original logical addresses are irregularly arranged, so the original logical addresses need to sort from beginning to end to construct an address mapping table, such as shown in the FIG. 1b, and to store the address mapping table in the SRAM. Even the obverse physical/logical address mapping table only construct partial portion to save the capacities of the SRAM, it also needs to sort from beginning to end from the logical address of the flash memory. The file system will provide an awaited-searching logical address at the data accessing and utilizes the software to search the address mapping table in the SRAM so as to constantly obtain a physical address corresponding to the logical address. Although, the method using the address mapping table to search the logical address, can provide with advantages of the short address transferring time and the fast processing speed, it requires huge amount of the SRAM to record all physical block address corresponding relation and it occupies huge space. Moreover, the recent trend is to integrate different functions in one single system chip (SOC), which the amount of the SRAM is fixed, so it cannot accord to requirement to increase the amount of the SRAM and causes the limitation of the application.

Another method is to infer the physical address from the logical address without the design of the SRAM or constructing any address mapping table, when it requires to find the corresponding logical address to the physical address, it only needs to utilize the software program to start the searching from the beginning of the flash memory space until to find the required logical address in the memory. The method without the design of the SRAM does not occupy the space, but its searching time is too low because the searching is from the beginning of the memory until to find the required logical address in the memory, so the speed of accessing data in the memory is very slow.

Obviously, the main spirit of the present invention is to obtain an effective balance in two kinds of the transferring method between the physical address and the logical address mentioned above, the present invention can simultaneously combine the problem of the speed and the space to effectively enhance the ability of accessing the data, and then some disadvantages of well-known technology are overcome.

### SUMMARY OF THE INVENTION

The primary object of the present invention is to provide a NAND type flash memory disk device and a method for detecting the logical address, which is to construct a physical/logical address mapping table (AMT) and to use the hardware to search the physical/logical address mapping table (AMT) so as to obtain the logical address which is respective to the physical address.

Another object of the present invention is to provide a NAND type flash memory disk device and a method for detecting the logical address, which is to utilize the calculation of the hardware and to cooperate using a few amount of the random access memory so as to simultaneously enhance the process speed of the semiconductor disk device without increasing too much space.

In order to achieve previous objects, at the beginning of the system turning, the flash memory disk device utilizes a relation between a physical address and its corresponding logical address at the beginning of turning-on the system to directly copies and constructs a partial inverse physical/logical address mapping table (AMT) and to stored in the random access memory (RAM). Owing to the present invention is to construct the partial inverse physical/logical address mapping table, so it completely does not need to sort from beginning to end and it only needs to directly copy partial content of the logical address of the flash memory. The system host will provide an awaited-searching logical address to a comparator when the system host is accessing data, at this time; a counter is transmitting an address signal to the static random access memory (SRAM). According to the address signal built-in in the partial inverse physical/logical address mapping table (AMT), a corresponding logical address signal is obtained and then to transfer to the comparator. The comparator is comparing the logical address signal and the awaited-searching logical address, which is provided by the system, until the logical signal and the awaited-searching logical address are equivalent so as to obtain its relatively physical address of the awaited-searching logical address and to stop an operation of the counter.

Other advantages of the present invention will become apparent from the following description taken in conjunction with the accompanying drawings wherein are set forth, by way of illustration and example, certain embodiments of the present invention.

### BRIEF DESCRIPTION OF THE DRAWINGS

The foregoing aspects and many of the accompanying advantages of this invention will become more readily appreciated as the same becomes better understood by reference to the following detailed description, when taken in conjunction with the accompanying drawings, wherein:

FIG. 1a and FIG. 1b are the schematic representation of the relation between the physical address and the logical address of the memory and the schematic representation of the physical/logical address mapping table (AMT) constructed by the relation, in accordance with the prior technology;

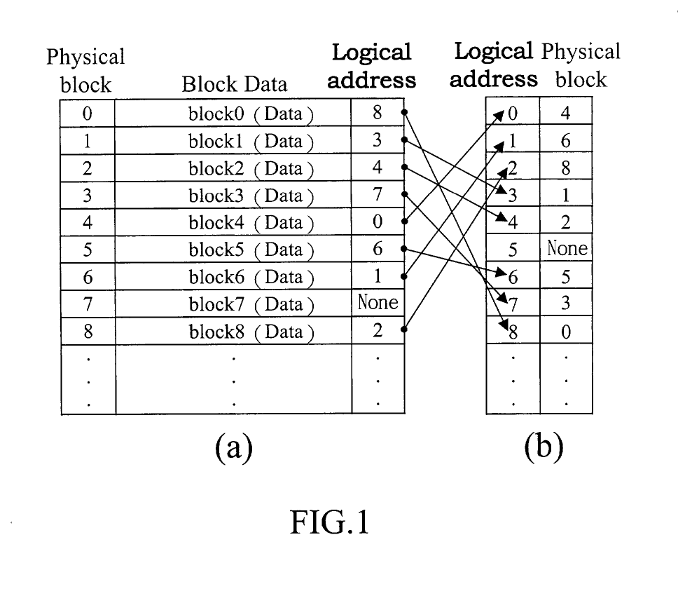

FIG. 2a and FIG. 2b are the schematic representation of the relation between the physical address and the logical address of the memory and the schematic representation of the physical/logical address mapping table (AMT) constructed by the relation, in accordance with the present invention;

FIG. 3 is a schematic representation of the semiconductor logical device, in accordance with the present invention; and

FIG. 4 is a schematic representation of the flow chart for detecting the logical address, in accordance with the present invention.

### DESCRIPTION OF THE PREFERRED EMBODIMENT

The present invention directly copies and constructs a partial inverse address mapping table, such as a partial physical/logical address mapping table (AMT) at the beginning of turning-on the system and to utilize the function of the hardware, such as a counter and a comparator, to match the characteristic of continuously reading/accessing of the random access memory (RAM) to search the physical/logical partial address mapping table (AMT) in a random access memory (RAM) to obtain the corresponding physical address to the logical address.

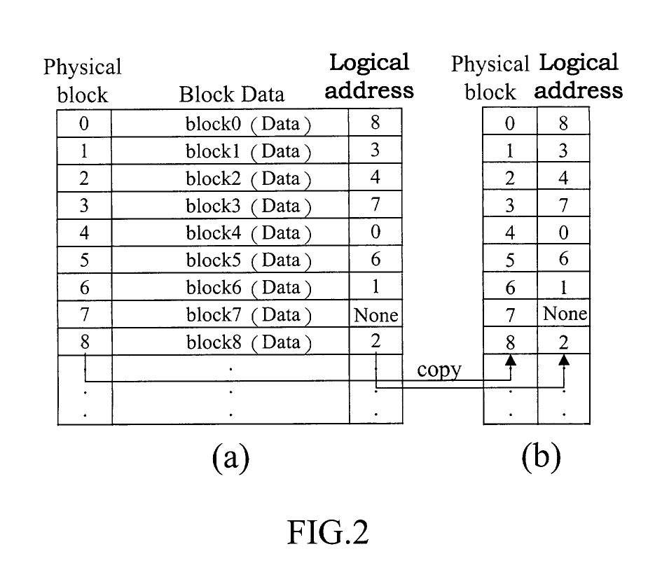

When the data-storing and the data-reading is executed in the flash memory, each data-accessing block provides with a physical address and its corresponding logical address, wherein the corresponding relation between the physical address and the logical address. When the file system is executed the initialization, a partial inverse address mapping table is copied and constructed according to the relation table of the FIG. 2a. At the same time, referring to the FIG. 2b, to construct the inverse address mapping table is mainly used the arrangement sequence of the logical address and then to copy the corresponding physical address into the content of the address mapping table so as to use the corresponding relation between the physical address and the logical address of the relation table to directly copy to form a physical/logical address mapping table. The present invention does not need to sort from beginning to end to construct an address mapping table. After forming the physical/logical address mapping table, the physical/logical address mapping table is stored in the static random access memory (SRAM) for providing the file system presently searching the awaited-searching logical address.

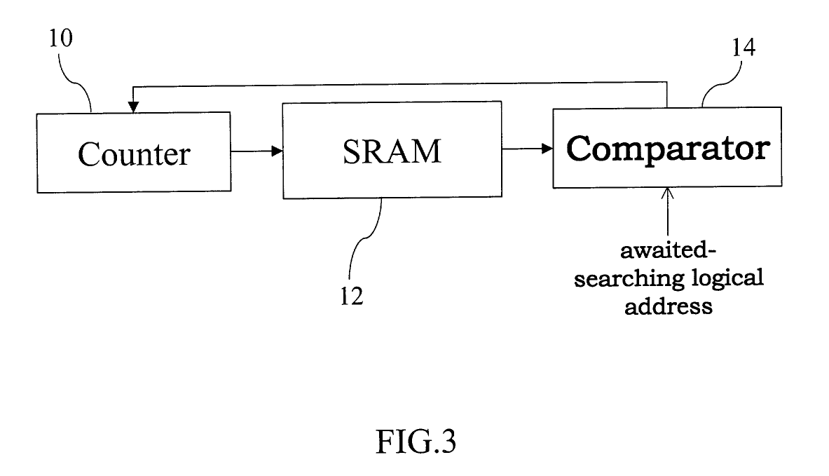

At the beginning of turning-on the file system, according to the size of the SRAM of the file system, the relation of the physical address and the logical address will directly copy and construct a partial inverse physical/logical address mapping table, such as shown in the FIG. 2b, and then to store the partial inverse physical/logical address mapping table in the static random access memory. The file system will provide an awaited-searching logical address to a comparator 14 when the data-accessing is executed, referring to the FIG. 3. At this time, a counter 10 will sequentially send a address signal to the static random access memory 12 for obtaining the SRAM content corresponding logical address signal according to the address signal from the partial inverse physical/logical address mapping table built-in in the static random access memory 12, and then to transfer the corresponding logical address signal to a comparator 14.

When the comparator 14 receives the logical address signal generated from the static random access memory 12, the comparator 14 will compare the content (logical address) and the awaited-searching logical address provided by the system, until the logical signal and the awaited-searching logical address are equivalent. And counter will stop by the equivalent signal at the same time, then the value of counter would be index corresponding physical address to the awaited-searching logical address.

Besides, if the comparing result is not equivalent, the counter 10 will continuously send next address signal to the static random access memory 12 and to repeat the procedure mentioned above until to search the equivalent logical address.

Wherein, if the partial inverse physical/logical address mapping table in the random access memory does not record the required logical address, the counter will count down and the file system will copy and construct another partial inverse physical/logical address mapping table and to repeat the forgoing procedure until to search the equivalent logical address.

Now, the principle of the present is dentally described in the forgoing. The following description will use an embodiment taken in conjunction with the flow chart to certificate the function and the effect of the semiconductor disk device mentioned above so as to enable any person skilled in the art to carry out the invention via the description of the following embodiment.

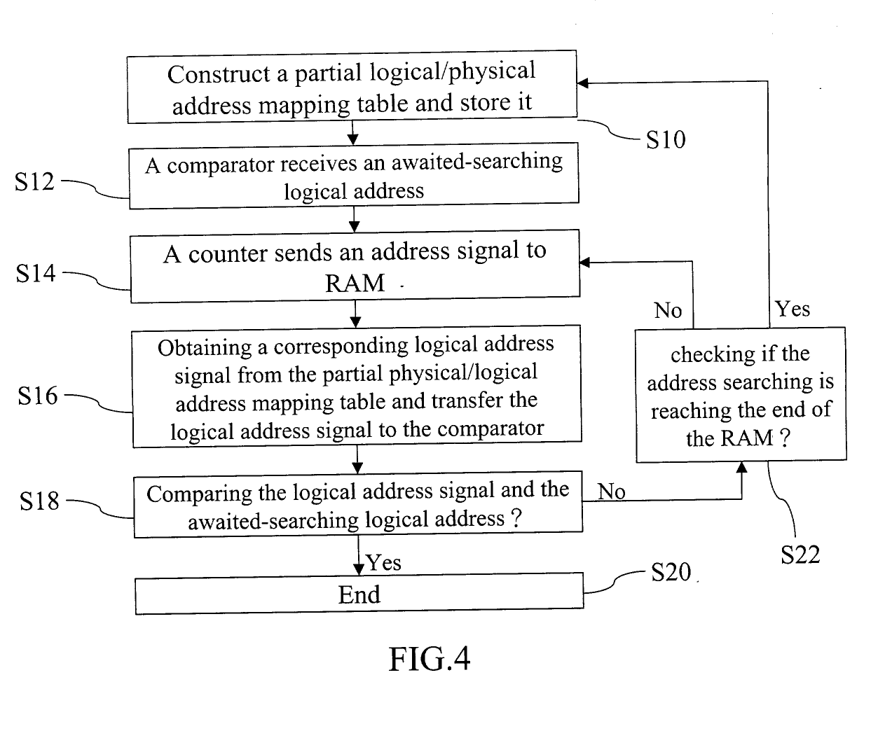

The FIG. 4 is a schematic representation of the flow chart for detecting the logical address in accordance with the present invention. Such as shown in the FIG. 4, the method for detecting -the logical address comprises the following steps. First, as shown in the step S10, the present invention directly copies and constructs a partial physical/logical address mapping table via the relation between the physical address and its corresponding logical address at the beginning of turning-on the system and then to store the partial physical/logical address mapping table in the random access memory.

When the system is transferring an awaited-searching logical address to a comparator, such as shown in the step S12, a counter is starting to send an address signal to the random access memory, such as shown in the step S14. After the random access memory receiving the address signal, the system accords to the address signal to obtain a corresponding logical address signal from the partial physical/logical address mapping table built-in in the random access memory, and immediately transfer the logical address signal to the comparator, as shown in the step S 16.

When the comparator 14 receives the logical address signal, the comparator will compare the logical address signal and the awaited-searching logical address provided whether both are equivalent, such as shown in the step 18. When the logical signal and the awaited-searching logical address are equivalent so as to present to obtain its corresponding physical address to the awaited searching logical address. Then, the circuit immediately stops the operation of the counter, such as shown in the step 20 to terminate the entire searching process. Besides, if the comparing result of the logical signal and the awaited searching logical address is not equivalent, the system is continuously executed the step S22 to check if the address searching is reaching the end of the random access memory. If the address searching is reaching the end of the random access memory, the partial inverse physical/logical address mapping table in the random access memory does not record the required logical address, so back to the step S10, the file system will copy and construct another partial inverse physical/logical address mapping table and to repeat the continuous procedure. If the address searching does not reach the end of the random access memory, so back to the step S14 and repeat the above steps until to obtain the awaited searching logical address and its corresponding physical address.

Owing to the partial inverse physical/logical address mapping table copied and constructed by the present invention is only partial address relation, so it does not need to occupy too much random access memory. Moreover, the present invention constructs a partial inverse physical/logical address mapping table, so it does not need to sort from beginning to end. The present invention only needs to directly copy the content of partial logical address of the flash memory, so it is faster than the prior art. Furthermore, the present invention utilizes the hardware of the semiconductor disk device to rapidly search the partial physical/logical address mapping table to obtain the corresponding logical address to the physical address. Hence, the present invention utilizes the calculation of the hardware and to cooperate using a few amount of the random access memory so as to simultaneously enhance the process speed of the semiconductor disk device without increasing too much space. The present invention can obtain an effective balance under the consideration of the speed and the space so as to combine the advantages of the fast processing speed and the occupied-free space to effectively enhance the ability of accessing the data

Of course, it is to be understood that the invention described herein need not be limited to these disclosed embodiments. Various modification and similar changes are still possible within the spirit of this invention. In this way, all such variations and modifications are included within the intended scope of the invention and the scope of this invention should be defined by the appended claims.

What is claimed is:

1. A NAND type flash memory disk device, wherein said flash memory disk device utilizes a relation between a physical address and its corresponding logical address at the beginning of turning-on the system to directly copies and constructs a partial inverse physical/logical address mapping table (AMT) so as to search a awaited-searching logical address by using said flash memory disk device, said flash memory disk device comprising:
a counter continuing transmitting a address signal;
a random access memory (RAM), wherein said partial inverse physical/logical address mapping table is recorded therein, and said random access memory (RAM) is according to said address signal to obtain a relatively logical address signal from said partial inverse physical/logical address mapping table (AMT) and then to transfer said logical address signal; and
a comparator for receiving said logical address signal and a awaited searching logical address and then comparing both until said logical signal and said awaited-searching logical address are equivalent so as to obtain its relatively physical address of said awaited-searching logical address and to stop an operation of said counter.

2. The NAND type flash memory disk device according to claim 1, further comprises copying and constructing another partial inverse physical/logical address mapping table (AMT) when said partial inverse physical/logical address mapping table in said random access memory does not record the required logical address signal.

3. The NAND type flash memory disk device according to claim 2, wherein said random access memory is a static random access memory (SRAM).

4. The s NAND type flash memory disk device according to claim 1, wherein said awaited-searching logical address is sent from the computer system.

5. A method for detecting a logical address, said method comprising following steps:
directly copying and constructing a partial inverse physical/logical address mapping table via a relation between a physical address and its corresponding logical address at the beginning of turning-on the system and storing said partial inverse physical/logical address mapping table (AMT) in a random access memory (RAM);
utilizing a counter to transmit a address signal to said random access memory as system transferring a awaited-searching logical address to a comparator;
said random access memory (RAM) according to said address signal to obtain a relatively logical address from said partial inverse physical/logical address mapping table (AMT) and transferring said logical address to said comparator; and
comparing said logical address and said awaited-searching logical address whether both are equivalent by said comparator until said two logical addresses are equivalent and to stop an operation of said counter so as to obtain its relatively physical address of said awaited-searching logical address.

6. The method for detecting a logical address according to claim 5, further comprises copying and constructing another partial inverse physical/logical address mapping table when said partial inverse physical/logical address mapping table (AMT) in said random access memory (RAM) does not record the required logical address signal.

7. The method for detecting a logical address according to claim 5, wherein said random access memory is a static random access memory (SRAM).
